(19) United States
(12) Patent Application Publication
(10) Pub. No.: US 2012/0103016 A1
(43) Pub. Date: May 3, 2012

(54) CUSTOM STONES AND METHODS FOR PRODUCING CUSTOM STONES FOR JEWELRY

(76) Inventor: Ippolita Rostagno, New York, NY (US)

(21) Appl. No.: 12/917,107

(22) Filed: Nov. 1, 2010

(51) Int. Cl. A44C 17/00; B28D 5/00

(52) U.S. Cl. 63/32; 125/30.01

(57) ABSTRACT

A stone for jewelry is provided that includes a first layer made of a first material; a second layer made of a second material bonded to the first layer; and a third layer made of a third material bonded to the second layer. The second material or layer is preferably made of a colored gel sheet.

### BACKGROUND OF THE INVENTION

The present application relates to stones and more particularly multi-layer stones for use in jewelry.

There exist a number of different kinds of stones used in jewelry and a corresponding number of different methods for producing those stones. Multi-layer stones are those produced with multiple layers of materials. For example, clear quartz may be disposed over a colored glass so that the quartz appears to take on the color of the glass. Although this process allows designers some freedom in varying the appearance of the stone, there are limits imposed primarily by the colors of the glass that are available. As such, there really is no easy and inexpensive way to produce stones with custom colors or other visible characteristics. Accordingly there is a need for a method or methods of producing custom stones that are so limited.

### SUMMARY OF THE INVENTION

A stone for jewelry is provided that includes a first layer made of a first material; a second layer made of a second material bonded to the first layer; and a third layer made of a third material bonded to the second layer, wherein the second material is a gel sheet.

In at least one embodiment, each of the first, second, and third layers have a color and the color of at least one of the layers differs from the color of another of the layers.

In at least one embodiment, each of the first, second, and third layers have a transparency and the transparency of at least one of the layers differs from the transparency of another of the layers.

In at least one embodiment, each of the first, second, and third layers have a pattern and the pattern of at least one of the layers differs from the pattern of another of the layers.

In at least one embodiment, each of the first and third layers have a faceting and the faceting of at least one of the layers differs from the faceting of another of the layers.

In at least one embodiment, each of the first, second, and third layers have a color, transparency, pattern, and a faceting and each of the color, transparency, pattern, and faceting of at least one of the layers differs from each of the color, transparency, pattern, and the faceting of another of the layers.

In at least one embodiment, the first layer is opaque and the third layer is clear, and the second layer is a color that differs from a color of the first and the second layers.

In at least one embodiment, the stone has a first axis and a second axis orthogonal to the first axis, and at least one of the first and third layers have a faceting, and wherein the faceting of at least one of the layers is asymmetrical about the first axis and the second axis.

In at least one embodiment, the stone has a first axis and a second axis orthogonal to the first axis, and a cut, and the cut is asymmetrical about at least one of the first axis and the second axis.

In at least one embodiment, a stone for jewelry that includes a first layer made of a opaque material; a second layer made of a transparent or translucent gel sheet bonded to the first layer; and a third layer made of a clear material bonded to the second layer. In this instance, the second layer has a color that differs from a color of the first and the third layers, the first and third layers have a faceting and the faceting of at least one of the layers differs from the faceting of another of the layers, and the stone has a first axis and a second axis orthogonal to the first axis, and wherein the faceting of at least one of the layers is asymmetrical about the first axis and the second axis.

In at least one embodiment, a method for producing a stone for jewelry is provided that includes the step or steps of: preforming at least one of a first layer made of a first material and a third layer made of a third material; bonding the first layer to a second layer made of a second material; bonding the third layer to the second layer, wherein the second material is a gel sheet, and cutting the stone and faceting at least one of the first layer and the second layer.

In at least one embodiment, the first and the second layers have inner surfaces that face each other in the stone, the method includes polishing the inner surfaces of each of the first and the third layers, and the first and the third layers are bonded to the second layer at the inner surfaces of each of the first and the third layers.

Additional aspects of the present invention will be apparent in view of the description which follows.

### BRIEF DESCRIPTION OF THE FIGURES

FIG. 1 is a cross sectional view of a multilayer stone according to at least one embodiment of the stones disclosed herein; and

FIG. 2 is a top view of a multilayer stone according to at least one embodiment of the stones disclosed herein.

### DETAILED DESCRIPTION OF THE INVENTION

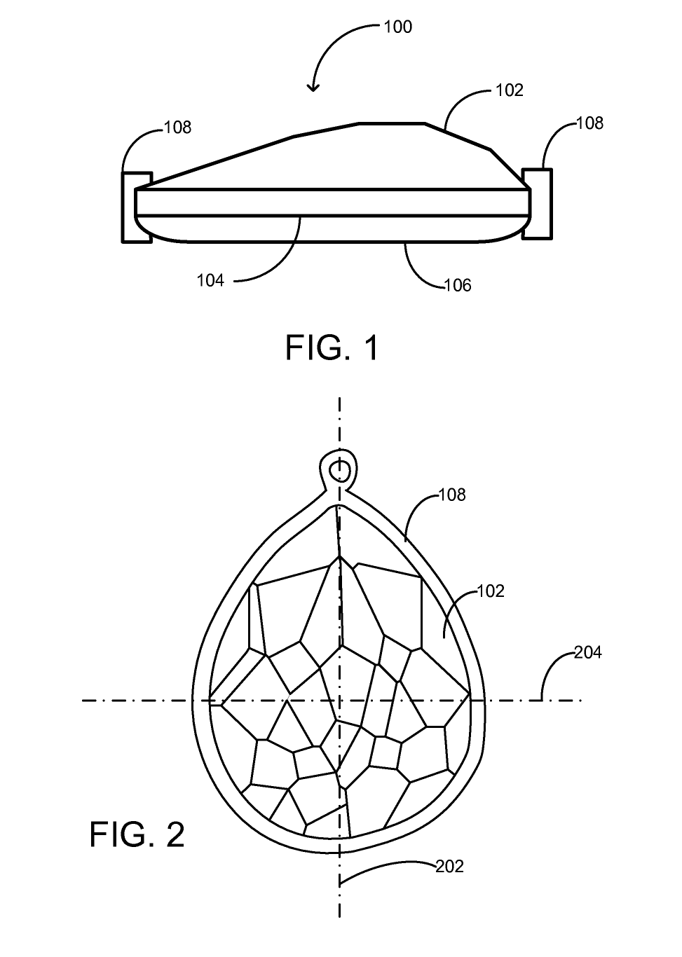

The present application generally provides custom stones and methods for producing those custom stones for jewelry. The term stone is used herein to any natural or synthetic material, or a combination thereof that may be placed in a jewelry setting, including brooches, bracelets, necklaces, pendants, rings, earrings etc. Referring to FIG. 1, in one embodiment of the stones disclosed herein, the stone includes multiple layers disposed over each other. Particularly, the stone 100 includes a first layer 106 disposed over a second layer 104, and preferably a third layer 102 disposed over the second layer 104. In a three-layer stone, the first layer 104 may be considered the bottom layer, the second layer 104 the middle layer, and the third layer 102 the top layer. The stone itself may be set in a setting 108.

The various layers of the stone may be made from various types of disparate materials, common types of materials having different visible and/or physical characteristics, or a combination thereof. A non-exhaustive list of materials is provided herein in Table A. For example, the bottom layer may be made from a first material, the middle layer form a second material, and the third layer from a third material. The first, second, and third materials may be the same materials with different visible characteristics, or different materials with similar or different visible characteristics. The different visible characteristics include transparency or opacity, color, hue, texture, cut, faceting, pattern, etc.

In at least one embodiment, the first, second, and third layers have at least one visible characteristic different from one another. For example, the top layer may be fully transparent, the middle layer less transparent, and bottom layer non-transparent or opaque. The different layers may differ in other visible characteristics as well. For example, the top layer may be clear, the middle layer may be a first color, and the bottom layer a third color. Similarly, the top layer may be faceted, or the top and bottom layer may be faceted whereas the middle layer is not faceted. The geometry of the faceting may differ between layers as well. For example, the top layer may be faceted in a traditional cut, including star and step cuts, mixed cuts, cuts with double facets, cuts with elongated brilliant facets, Maltese cross cut, etc., or non-traditional cuts, whereas the bottom layer may be cut cabochon or cabochon cuts with a flat, curved or domed tops.

In at least one embodiment, the middle layer is made from a gel or color material with a desired transparency and/or color. The gel layer is preferably a thin sheet or sheets of extruded polycarbonate or dyed polyester that is adhered to the top and bottom layers, such as those marketed by Roscoe and Lee Filters. The gel layer beneficially allows designers to tailor and vary the overall color of the stone easily and relatively inexpensively. Designers may use readily available colors, mix readily available colors by using multiple gel layers, or specify custom gel colors.

The gel layer or layers are preferably bonded to the top and bottom layers. The bond may be created in a variety of ways. The bond is preferably created with glue that does not react adversely with the gel layer. For example, the bond may be created with a Sparkle heavy bond 2 part ZMT epoxy or other similar glue.

As noted herein, the stone may be in a traditional or non-traditional cut. Referring to FIG. 2, in one embodiment, the stone has a non-traditional cut and/or faceting. That is, at least the upper layer 102 of the stone has one of an asymmetrical cut or faceting. For example, the cut may be a pair shape whereas the faceting may be asymmetrical about at least one axis 202, 204, including a first axis 202 and a second orthogonal axis 204 relative to the first axis. In this instance, the cut is preferably symmetrical about at least one axis, e.g., the first axis 202. Similarly, the cut may be asymmetrical about the first axis 202 and/or the second axis 204, with our without symmetrical cuts. In addition to being asymmetrical, the faceting may have a random or an apparent random appearance. The asymmetrical cut and/or faceting, when combined with the gel layer, provides a distinct, visually appealing stone that is customized easily and relatively inexpensively.

The stone disclosed herein may be produced in a variety of ways. The stones may be produced as described in the following Examples, which are set forth to aid in the understanding of the invention, and should not be construed to limit in any way the scope of the invention as defined in the claims which follow thereafter.

### EXAMPLES

### Process 1

In one embodiment, the stone is produced by first preforming the top layer and the bottom layer in the general overall shape of the stone. The top layer may be clear quartz and the bottom layer mother of pearl. The layers have inner sides or surfaces that face each other in the final stone. The inner sides of each layer are polished so that the surfaces are flat and free from defects that may be visible in the stone. The bonding compound, e.g. the epoxy glue, may then be applied to the inner surface of the mother of pearl layer, and the gel layer placed over the inner surface of the mother of pearl layer. The bonding compound may then be applied to the gel layer and the clear quart layer may be placed over the gel layer. As noted herein, multiple gels may be used, in which instance the process involves further placing the second gel layer over the first gel layer, followed by applying the bonding compound to the second gel layer. The layers are then pressed together and the bonding compound is allowed to cure. Once cured, the stone may be cut, facetted, and set in a desired setting. This process works well for larger, thinner stones.

### Process 2

In one embodiment, the stone is produced by first cutting and faceting the top layer and the bottom layer. The top layer may be clear quartz and the bottom layer mother of pearl. The layers have inner sides or surfaces that face each other in the final stone. The bonding compound, e.g. the epoxy glue, may then be applied to the inner surface of the mother of pearl layer, and the gel layer placed over the inner surface of the mother of pearl layer. The bonding compound may then be applied to the gel layer and the clear quart layer may be placed over the gel layer. With multiple gel layers the second gel layer is placed over the first gel layer and bonding compound is applied over the second gel layer. The layers are then pressed together and the bonding compound is allowed to cure. Once cured, the stone may be set in a desired setting. This process works well for smaller, thicker stones.

### Process 3

In one embodiment, the stone is produced by first cutting the top layer and preforming the bottom layer in the general overall shape of the stone. The top layer may be clear quartz and the bottom layer mother of pearl. The layers have inner sides or surfaces that face each other in the final stone. The bonding compound may then be applied to the inner surface of the mother of pearl layer, and the gel layer placed over the inner surface of the mother of pearl layer. The bonding compound may then be applied to the gel layer and the clear quart layer may be placed over the gel layer. The layers are then pressed together and the bonding compound is allowed to cure. Once cured, the stone may facetted on both sides and set in a desired setting.

While the foregoing invention has been described in some detail for purposes of clarity and understanding, it will be appreciated by one skilled in the art, from a reading of the disclosure that various changes in form and detail can be made without departing from the true scope of the invention.

APPENDIX - TABLE A

| | | | |
|---|---|---|---|
| Achroite | Agate | Alexandrite | Almandite |
| Amazonite | Amber | Amblygonite | Amethyst |
| Ametrine | Ammolite | Ammonite | Andalusite |
| Andradite | Anglesite | Apache tears | Apatite |
| Apophyllite | Aquamarine | Aventurine | Azurite |
| Benitoite | Beryl | Bixbite | Bloodstone |
| Brazilianite | Cairngorm | Calcite | Carnelian |
| Cassiterite | Cerussite | Cat's-Eye | Chalcedony |
| | | Chrysoberyl | |
| Charoite | Chiastolite | Chrome | Chrysoberyl |
| | | Tourmaline | |
| Chrysocolla | Chrysoprase | Citrine | Copal |
| Coral | Cordierite | Cornelian | Corundum |
| Crocoite | Cuprite | Danburite | Demantoid |
| Diamond | Diaspore | Diopside | Dioptase |
| Dravite | Emerald | Enstatite | Eosphorite |
| Epidote | Euclase | Feldspar | Fire Agate |
| Fluorite | Garnet | Glass | Goldstone |
| Goshenite | Green Beryl | Greened | Grossularite |
| | | Amethyst | |
| Hambergite | Helenite | Heliodor | Heliolite |
| Hematite | Hessonite | Hiddenite | Howlite |
| Iceland spar | Idocrase | Indicolite | Iolite |
| Ivory and Bone | Jade | Jadeite | Jasper |
| Jeremejevite | Jet | Korite | Kornerupine |
| Kunzite | Kyanite | Labradorite | Lapis Lazuli |
| Larimar | Lazulite | Lazurite | Leucite |
| Malachite | Malaya Garnet | Marcasite | Moissanite |
| Moldavite | Moonstone | Morganite | Morton |
| Mt. St. Helens | Nephrite | Obsidian | Olivine |
| Stone | | | |
| Onyx | Opal | Orthoclase | Paste |
| Pearl and Mother | Pectolite | Peridot | Petalite |
| of Pearl | | | |
| Petoskey Stone | Petrified Wood | Phenakite | Plushstone |
| | and Bone | | |
| Prasiolite | Prehnite | Proustite | Pyrite |
| Pyrope | Quartz | Red Beryl | Rhodochrosite |
| Rhodizite | Rhodolite | Rhodonite | Rock Crystal |
| Rose Quartz | Rubellite | Ruby | Rutile |
| Sapphire | Sard | Sardonyx | Scapolite |
| Serpentine | Sinhalite | Smoky Quartz | Sodalite |
| Spectrolite | Spessartite | Sphalerite | Sphene |
| Spinel | Spodumene | Sugilite | Sunstone |
| Taafeite | Tanzanite | Tektite | Tigereye |
| Titanite | Topaz | Topazolite | Tourmaline |
| Triphane | Tsavolite | Tsavorite | Turquoise |
| Turritella | Uvarovite | Variscite | Vermarine |
| Wulfenite | Zincite | Zircon | Zoisite |

What is claimed is:

1. A stone for jewelry comprising:
a first layer made of a first material;
a second layer made of a second material bonded to the first layer; and
a third layer made of a third material bonded to the second layer, wherein the second material is a gel sheet.

2. The stone of claim 1, wherein each of the first, second, and third layers have a color and wherein the color of at least one of the layers differs from the color of another of the layers.

3. The stone of claim 1, wherein each of the first, second, and third layers have a transparency and wherein the transparency of at least one of the layers differs from the transparency of another of the layers.

4. The stone of claim 1, wherein each of the first, second, and third layers have a pattern and wherein the pattern of at least one of the layers differs from the pattern of another of the layers.

5. The stone of claim 1, wherein each of the first and third layers have a faceting and wherein the faceting of at least one of the layers differs from the faceting of another of the layers.

6. The stone of claim 1, wherein each of the first, second, and third layers have a color, transparency, pattern, and a faceting and wherein each of the color, transparency, pattern, and faceting of at least one of the layers differs from each of the color, transparency, pattern, and the faceting of another of the layers.

7. The stone of claim 6, wherein the first layer is opaque and the third layer is clear, and the second layer is a color that differs from a color of the first and the second layers.

8. The stone of claim 1, wherein the stone has a first axis and a second axis orthogonal to the first axis, and wherein at least one of the first and third layers have a faceting, and wherein the faceting of at least one of the layers is asymmetrical about the first axis and the second axis.

9. The stone of claim 8, wherein the stone has a first axis and a second axis orthogonal to the first axis, and a cut, and wherein the cut is asymmetrical about at least one of the first axis and the second axis.

10. A stone for jewelry comprising:
a first layer made of a opaque material;
a second layer made of a transparent gel sheet bonded to the first layer; and
a third layer made of a clear or translucent material bonded to the second layer, wherein the second layer has a color that differs from a color of the first and the third layers, the first and third layers have a faceting and the faceting of at least one of the layers differs from the faceting of another of the layers, and wherein the stone has a first axis and a second axis orthogonal to the first axis, and wherein the faceting of at least one of the layers is asymmetrical about the first axis and the second axis.

11. A method for producing a stone for jewelry comprising:
preforming at least one of a first layer made of a first material and a third layer made of a third material;
bonding the first layer to a second layer made of a second material;
bonding the third layer to the second layer, wherein the second material is a gel sheet, and
cutting the stone and faceting at least one of the first layer and the second layer.

12. The method of claim 11, wherein each of the first, second, and third layers have a color and wherein the color of at least one of the layers differs from the color of another of the layers.

13. The method of claim 11, wherein each of the first, second, and third layers have a transparency and wherein the transparency of at least one of the layers differs from the transparency of another of the layers.

14. The method of claim 11, wherein each of the first, second, and third layers have a pattern and wherein the pattern of at least one of the layers differs from the pattern of another of the layers.

15. The method of claim 11, wherein each of the first and third layers have a faceting and wherein the faceting of at least one of the layers differs from the faceting of another of the layers.

16. The method of claim 11, wherein each of the first, second, and third layers have a color, transparency, pattern, and a faceting and wherein each of the color, transparency, pattern, and faceting of at least one of the layers differs from each of the color, transparency, pattern, and the faceting of another of the layers.

17. The method of claim 16, wherein the first layer is opaque and the third layer is clear, and the second layer is a color that differs from a color of the first and the second layers.

18. The method of claim 11, wherein the stone has a first axis and a second axis orthogonal to the first axis, and wherein at least one of the first and third layers have a faceting, and wherein the faceting of at least one of the layers is asymmetrical about the first axis and the second axis.

19. The method of claim 18, wherein the stone has a first axis and a second axis orthogonal to the first axis, and a cut, and wherein the cut is asymmetrical about at least one of the first axis and the second axis.

20. The method of claim 11, the first and the second layers have inner surfaces that face each other in the stone, the method comprising polishing the inner surfaces of each of the first and the third layers, and wherein the first and the third layers are bonded to the second layer at the inner surfaces of each of the first and the third layers.
